(19) United States
(12) Patent Application Publication
(10) Pub. No.: US 2017/0167885 A1
(43) Pub. Date: Jun. 15, 2017

(54) GPS ROUTING BASED ON DRIVER

(71) Applicant: International Business Machines Corporation, Armonk, NY (US)

(72) Inventors: DARRYL M. ADDERLY, Morrisville, NC (US); JONATHAN W. JACKSON, Durham, NC (US); AJIT JARIWALA, Cary, NC (US); ERIC B. LIBOW, Raleigh, NC (US)

(21) Appl. No.: 14/965,764

(22) Filed: Dec. 10, 2015

(51) Int. Cl. G01C 21/36; G01S 19/42

(52) U.S. Cl. CPC G01C 21/3626; G01S 19/42

(57) ABSTRACT

A global positioning system (“GPS”) receives a destination location from a current driver of a vehicle. A GPS route planning process of the GPS identifies potential routes for the vehicle to the destination location. A data analysis process of the GPS rates the potential routes based on how characteristics of the potential routes relate to characteristics of the current driver. The GPS route planning process selects a route for the current driver responsive to the ratings. The GPS displays the selected route to the driver on a display.

### FIELD OF THE INVENTION

The present invention concerns global positioning system (“GPS”) routing, and more particularly GPS routing decisions wherein driver and route analytics are included in the decisions.

### BACKGROUND

GPS units for cars range from stand-alone devices, to applications installed on a smart phone, to systems integrated into a car's control console, which typically includes an entertainment system. These units may incorporate route information to give the user a better, safer GPS route.

### SUMMARY

A method is provided for global positioning system routing, including receiving, by a GPS, a destination location from a current driver of a vehicle and identifying, by a GPS route planning process of the GPS, potential routes for the vehicle to the destination location. A data analysis process of the GPS rates the potential routes based on how characteristics of the potential routes relate to characteristics of the current driver. The GPS route planning process selects a route for the current driver responsive to the ratings. The GPS displays the selected route to the driver on a display.

In an additional aspect of an embodiment, the characteristics of the current driver include experience history.

In an additional aspect of an embodiment, the experience history indicates respective amounts of driving experience of the current driver on roads of predetermined characteristics included in the characteristics of the potential routes.

In an additional aspect of an embodiment, the characteristics of the current driver comprise historical driving behavior.

In an additional aspect of an embodiment, the driving behavior includes accidents and moving traffic violations.

In an additional aspect of an embodiment, the characteristics of the potential routes comprise speed limits on respective segments of the potential routes.

In an additional aspect of an embodiment, the ratings include ratings indicating to avoid a segment of a potential route.

Other embodiments of the invention are disclosed and claimed, including a computer system implementation and a computer program product.

### BRIEF DESCRIPTION OF THE DRAWINGS

Novel features believed characteristic of the invention are set forth in the appended claims. The invention itself, however, as well as a preferred mode of use, objectives and advantages thereof, will best be understood by reference to the following detailed description of an illustrative embodiment when read in conjunction with the accompanying drawings, wherein:

FIG. 1 provides a block diagram of a GPS, according to embodiments of the present invention.

FIG. 2 illustrates a GPS user interface, according to embodiments of the present invention.

FIG. 3 illustrates a computer system that is generally applicable for aspects of embodiments of a host computer system or a user's personal mobile device described herein, according to embodiments of the present invention.

FIG. 4 illustrates an embodiment of GPS device, according to embodiments of the present invention.

FIG. 5 provides a block diagram of processes, according to embodiments of the present invention.

FIG. 6 provides a flow chart showing actions, including actions performed by processes of a GPS, according to embodiments of the present invention.

### DETAILED DESCRIPTION

In the following detailed description of preferred embodiments, reference is made to the accompanying drawings illustrating embodiments in which the invention may be practiced. It should be understood that other embodiments may be utilized and changes may be made without departing from the scope of the present invention. The drawings and detailed description are not intended to limit the invention to the particular form disclosed. On the contrary, the intention is to cover all modifications, equivalents and alternatives falling within the spirit and scope of the present invention as defined by the appended claims. Headings throughout this document are not intended to limit the subject matter in any way.

Herein disclosed is GPS technology for a vehicle that integrates information to decide a route to drive, wherein the information includes data about the driver of the vehicle, which may result in safer GPS routes based on driver level analytics. According to embodiments of the present invention, a GPS route planning process uses any or all of highway (or other road), shortest time and shortest distance metrics for determining route, and may further apply geography-related, traffic-related and safety-related analytics, for example, as well as driver-related analytics for the current driver of the vehicle for determining route. That is, a disclosed GPS route planning process receives demographic data for the current driver, including, among other things, data indicating age, sex, and driving experience. Responsive to the driver-related analytics for the current driver, the GPS route planning process enhances both initial route selection and re-routing performed during a trip, to provide the safest or otherwise best route for that particular driver. Thus, it should be understood that the GPS route planning process may select a different route for a different driver, depending on the driver's age, sex, and driving experience, for example, and the combination of those driver-related characteristics and characteristics of roads, time, distance and geography.

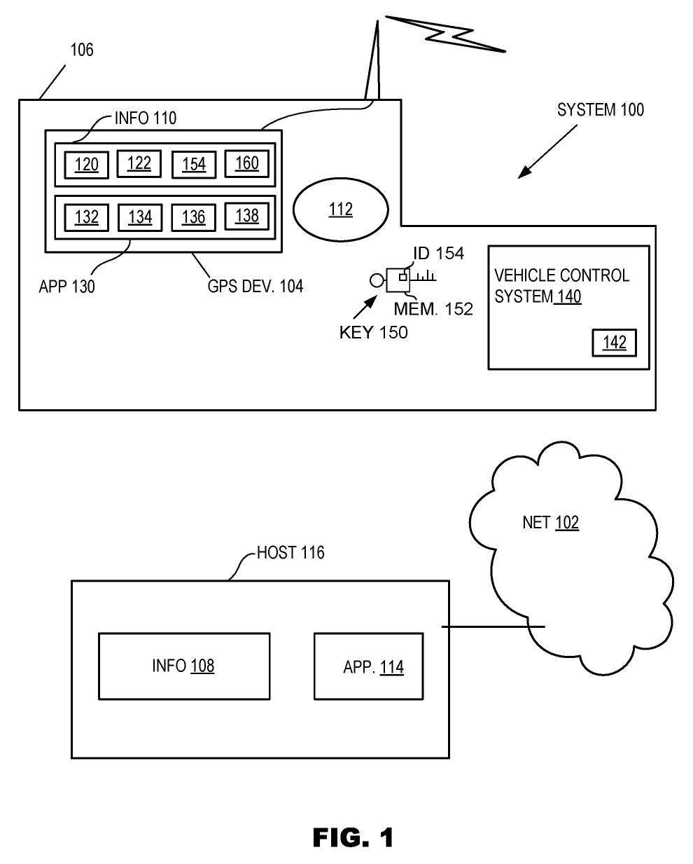

According to an embodiment of the present invention as shown in FIG. 1, a system 100 provides network 102 communication so that a GPS user device 104 of a vehicle 106 for driver 112 has access to information 108 obtained by remote host 116 for driver 112. In vehicle 106, network-connected GPS device 104, itself, captures information 110 for driver 112, including key identity data 154, road segment data 160, driver identity data 120 and driving data 122, where driving data 122 may include data about on-going driver 112 behavior.

According to some embodiments of the present invention, device 104 delivers information 110 to networked host 116 for storage and access by an application 114 executing thereon or receives information 108 from host 116 for use by a GPS route planning application 130 executing on device 104, or both delivers info 110 and receives info 108, where data 110 may include driver identity data 120 and driving data 122 captured by GPS device 104 and obtained from data 108 and where data 108 may include driver identity data 120 and driving data 122 in addition to data captured by GPS device 104 or may be limited to identity data 120 and driving data 122 originally captured by device 104, depending upon the embodiment.

GPS route planning application 130 on device 104, application 114 on host 116, or both applications 114 and 130, execute program modules for performing route planning, data analysis, collection/initialization, identification and other functions via processes 132, 134, 136, 138 and others to use information 110, information 108 or both for enhancing navigation in a manner specific to the particular driver 112, which reduces the likelihood of wrong decisions by driver 112 at ambiguous points in the road and improves safety.

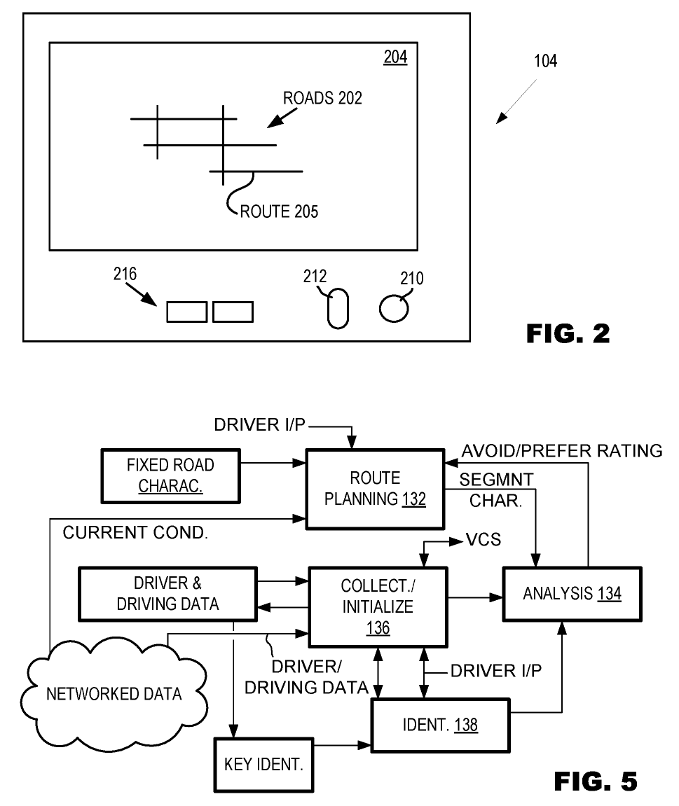

Referring now to FIG. 2, enhanced, network-connected GPS device 104 presents maps depicting roads 202 on a user interface display 204. In addition, display 204 also visually depicts routes 205 on selected segments of selected roads 202 that app 130 or 114, or both in cooperation, select for the particular driver 112. GPS device 104 has a speaker 210 that is configured for use to audibly announce upcoming turns and the like, such as “Turn left at the intersection of Main Street and Central Avenue.”

Referring now to both FIGS. 1 and 2, the enhanced, network-connected GPS device 104 enables a driver 112 to derive enhanced navigation from information 108 and 110 for the particular driver 112 driver during a trip or by planning ahead. During a trip, a driver 112 can receive answers from system 100 responsive to the driver's questions spoken to a microphone 212 of device 104, such as, for example, “What is the best route from here to Central Avenue and Pecan Street?” Driver 112 can specify criteria for how application 114 selects the answers, as explained further herein below.

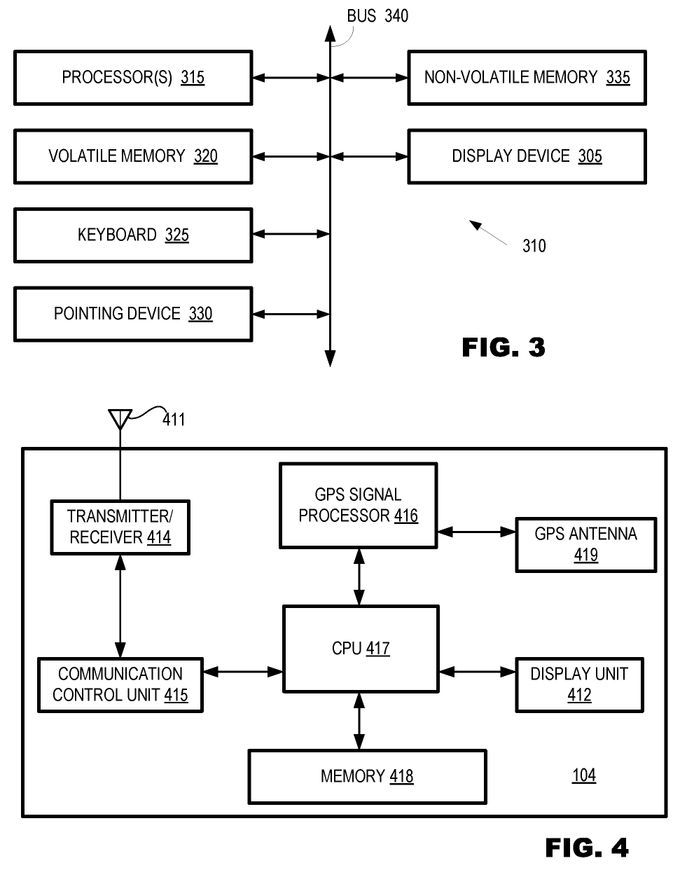

In FIG. 3, a computer system 310 is shown that is generally applicable for aspects of embodiments of host computer system 116 or a user's personal mobile device described herein. Computer system 310 includes one or more processors 315, a volatile memory 320, e.g., RAM, a keyboard 325, a pointing device 330, e.g., a mouse, a nonvolatile memory 335, e.g., ROM, hard disk, floppy disk, CD-ROM, and DVD, and a display device 305 having a display screen. Memory 320 and 335 are for storing data such as information 108 (FIG. 1) and program instructions, such as for application 114 (FIG. 1), which are executable by processor 315 to implement various embodiments of a method in accordance with the present invention. Components included in system 310 are interconnected by bus 340. A communications device (not shown) may also be connected to bus 340 to enable information exchange between system 310 and other data carriers. System 310 may, of course, include additional elements and may omit some elements described herein, according to embodiments of the present invention.

In various embodiments computer system 310 takes a variety of forms, including a personal computer system, mainframe computer system, workstation, Internet appliance, PDA, an embedded processor with memory, etc. That is, it should be understood that the term “computer system” is intended to encompass any device having a processor that executes instructions from a memory medium.

FIG. 4 illustrates an embodiment of GPS device 104 that includes a communication antenna 411, a transceiver 414, a communication control unit 415, a GPS antenna 419, a GPS signal processor 416, a memory 418, a display/input unit 412 and a central processing unit 417. Transceiver 414 modulates and demodulates signals for transmitting and receiving data via communication antenna 411 to and from transceivers 420 of cellular network 422, which transceiver 414 does under control of communication control unit 415. GPS antenna 419 receives GPS signals from GPS satellites (not shown), and GPS signal processor 416 operates for processing of the GPS signals received via the GPS antenna 419. Memory 418 temporarily stores signals received via communication antenna 411 and the GPS antenna 419 and also stores instructions and data for CPU 417. Display/input unit 412 presents map images, etc. CPU 417 stores the GPS signals received via GPS antenna 419 in memory 418, receives signals such as map image data received via communication antenna 411 and demodulated by transceiver 414, receives touch-based user input and delivers the input to communication control unit 415, etc. Device 104 may, of course, include additional elements and may omit some elements described herein, according to embodiments of the present invention.

GPS route planning process 132 provided by execution of a GPS route planning program module of application 130 receives start and destination locations from the driver and identifies potential routes for traversing between the received locations in a well-known manner, except that GPS route planning process 132 avoids selecting or affirmatively selects certain road segments for potential routes based on how characteristics of the respective segments relate to characteristics of current driver 112, as determined by data analysis process 134, according to embodiments of the present invention. (The elimination may occur either before route planning process 132 selects potential segments to assemble into a potential route or after process 132 assembles segments into a potential route, according to various embodiments of the present invention.)

It should be noted that categorizing performed by app 130, according to embodiments of the present invention, is more than a preference received as a choice input by driver 112, such as a driver preference to avoid roads categorized as highways, for example. Rather, collection and initialization process 136 sends to data analysis process 134 the driving data 122 collected for current driver 112, which may include experience history and history of accidents, moving traffic violations and other driver behavior data, etc., as described herein, and sends driver demographic information, which may be included in driver identity data 120, as described herein. Also, planning process 132 selects road segments for a potential route and sends road segment data 160 identifying the segments to data analysis process 134, which is provided by executing application 130.

Further, planning process 132 includes characteristics of each road segment of a potential route in road segment data 160 that it sends, wherein data 160 may include not only relatively fixed characteristics for a road segment, such as speed limit, lighting, clearances, whether the road has limited access, median, traffic lights, etc., but also may include current driving conditions on the segment, such as weather, time of day and traffic, for example, since data analysis process 134 uses not only fixed road segment characteristics but also current road segment conditions to determine whether a road segment is suited for a particular driver 112 at the present time. This is because data analysis process 134 may determine in two instances that fixed characteristics of a road segment are suitable for two different drivers, but may determine that current road segment conditions in one instance are not suitable for one of the two drivers based on different driving data 122 and driver identity data 120 collected for the different drivers.

In response to receiving data from route planning process 132 and from collection and initialization process 136, data analysis process 134 responsively analyzes received characteristics for each road segment of a potential route and received characteristics for driver 112, i.e., driving data 122 and driver identity data 120, and generates an avoidance category for each road segment for the particular driver 112, i.e., based on the road segment characteristic and the experience, history, driving record, other driver behavior, etc. of current driver 112.

According to embodiments of the present invention, data analysis process 134 may generate an avoidance category for a road segment responsive to the received road segment and driver characteristics by selecting from simple, binary categories, i.e., avoid/do not avoid. In variations, data analysis process 134 may generate an avoidance category that is a rating for a road segment by selecting from categories indicating an avoidance degree, such as categories 1 through 10 or some other scale, where a category on one end of the scale indicates avoidance is not necessary and a category on the other end of the scale indicates must avoid, if possible, for example. In variations, data analysis process 134 may generate a rating that is not merely neutral at one end of the scale but rather indicates a degree of desirability. For example, data analysis process 134 may select from categories 1 through 10, or some other scale, where one end of the scale indicates the road segment is preferred and should, therefore, be selected for a route, unless other more desirable segments are available, mid-scale indicates the road segment is neither desirable nor undesirable, and the other end of the scale indicates the road segment must be avoided, if avoidance is possible.

GPS route planning process 132 avoids selecting or affirmatively selects road segments for potential routes based on the categories or ratings of the road segments received from data analysis process 134, according to embodiments of the present invention. For example, process 132 may
avoid road segments having a certain speed limit for a driver who has tickets on road segments with that speed limit
avoid routing that requires a left turn across three lanes of traffic for a driver with limited experience
avoid traffic for an experienced driver
avoid construction for an inexperienced driver
select road segments that have characteristics the current driver has experienced and avoid segments for which the current driver only has limited experience. For example, for an inexperienced driver, such as a teenage driver who only drives to school and back and is a single male driver under the age of 25 who is driving a muscle car
   avoid road segments deemed by data analysis process 134 as undesirable due to the following
      winding road
      road with elevation change
      road with ditches on the side
      road with traffic lights placed on the side instead of above the road
      road with street names placed on the side instead of above the road
      water crossing where water is likely to be above the vehicle's road clearance
   select road segments deemed by data analysis process 134 as desirable due to the following
      low accident rates
      non-highways
      divided boulevards

Fixed characteristics of segments in road segment data 160 may be preloaded, such as into GPS device 104 memory 418 by the device manufacturer or by collection and initialization process 136 (or a process of some other module of application 130), which may obtain or update fixed characteristics and obtain current condition characteristics from remote data via network 102 and/or vehicle sensors of vehicle control system 140.

According to embodiments of the present invention, application 130 is configured with a program module for driver initialization, such that execution of application 130 provides a collection and initialization process 136 that collects driving data 122 for the particular driver 112 who is currently driving vehicle 106, i.e., data relating to driving issues for driver 112. In one way of collecting driving data 122, collection and initialization process 136 runs and queries driver 112 for driving issues in a manner such as described herein above regarding initializing driver identity.

Driving issues collected for driving data 122 of a particular driver 112 may include i) experience level, ii) records of accidents, which may include types of accidents, i.e., categories regarding how accident occurred, such as defined by American National Standards Institute “Manual on Classification of Motor Vehicle Traffic Accidents” (e.g., single car/multi-car, other driver turned left in front of current driver, lane change, other lane departure, insufficient following distance, excessive speed, collision at junction and nature of junction, etc.), including driving conditions in which accident occurred and where it occurred (i.e. what specific location on what specific road) and iii) moving traffic violations, which may include type of violation, including how it occurred (e.g., exceeding a speed limit, driving at unsafe speed, failing to maintain sufficient following distance, failure to stop at sign or traffic light, failure to yield to vehicle having right-of-way, failure to signal turn or lane change, failure to stay in lane, crossing center divider or the like, driving on shoulder, failure to stop for pedestrian, failure to stop for school bus, etc.).

Experience level may be defined by i) estimated number of total hours driven or distance driven and estimated number or percentage of hours or distance driven on various types of roads, such as local streets with stop lights, non-divided highways, limited access, divided highways, etc., and ii) driving conditions experienced and estimated number or percentage of hours or distance driven in the given driving conditions, such as i) day or night, ii) types of weather, e.g., wet, ice and snow, iii) levels of traffic, e.g., light, moderate and heavy, etc.

In another way of collecting driving data 122 specific to driver 112, who is identified by driver identity data 120, collection and initialization process 136 communicates with databases of governmental agencies, such as the National Highway Traffic Safety Administration (NHTSA) and the State of record where driver 112 is licensed, and of insurance providers and the like, wherein collection and initialization process 136 collects any or all of records including accidents, moving traffic violations and other recorded behavior for driver 112, which may include telematics records of driver behavior, such as distance driven, speed, time of day, braking force, etc., as described, for example, by U.S. Pat. No. 5,797,134 and European Patent EP0700009B1.

In another way of collecting driving data 122 specific to driver 112, who is identified by driver identity data 120, collection and initialization process 136 collects historical data via operation of GPS unit 104 and vehicle control system sensors, such as a camera and a remote distance measuring device (e.g., radar or ultrasonic based), that occurs when driver 112 is operating vehicle 106, including driver behavior and data related to experience level, such as described herein. This may include collecting driver 112 behavior and situations such as described that do not involve accidents or governmentally recorded traffic violations, but that involve similar behavior such as described herein regarding traffic violations, such as, for example, exceeding a speed limit, driving at unsafe speed, failing to maintain sufficient following distance, failure to stop at sign or traffic light, failure to yield to vehicle having right-of-way, failure to signal turn or lane change, failure to stay in lane, crossing center divider or the like, driving on shoulder, etc.

According to embodiments of the present invention, collection and initialization process 136 also prompts a driver 112 to initialize driver identity data 120. This may be done in various ways. Collection and initialization process 136 may execute on GPS unit 104 as part of GPS application 130, for example, or may execute on a separate device, such as a smart phone or other computer system, such as host 116.

In one way of initializing driver information, collection and initialization process 136 executes on GPS unit 104 and communicates with driver 112 by sending and receiving messages via a display console 142 used by a vehicle control system 140 for driver notification and input. In another way, GPS unit 104 includes a display (as in FIG. 2, display 204) separate from display console 142 used by a vehicle control system 140, and collection and initialization process 136 communicates with driver 112 by sending and receiving messages, such as via a display 204 of GPS unit 104. Process 136 may also communicate using voice simulation and voice recognition processes via GPS device 104. In one variation, collection and initialization process 136 executes on a smart phone or other personal mobile device and communicates with driver 112 by sending and receiving messages via such device. This may include driver 112 sending identity data 120 for driver 112 that already exists on a smart phone or other computer system.

Identity data 120 includes, in variations, the name of driver 112, and may include driver's license number, age, gender, etc. Identity data 120 or driving data 122 may also include data identifying characteristics of vehicle 106, such as vehicle height (for clearance of vehicle 106 below bridges and building structures, such as in parking garages) and road clearance (for clearance of vehicle 106 above matter on the road, such as water, for example), which a process of GPS, such as collection and initialization process 136, may obtain via communication with vehicle control system 140, for example.

According to embodiments of the present invention, collection and initialization process 136 also prompts driver 112 to associate a key 150 of driver 112, which is used to start a vehicle 106, with received identity data 120. (Although referred to herein as a “key,” it should be understood that key 150 may be a remote controller used by a driver with a keyless ignition system. Such a remote controller may be an electronic device that is sometimes referred to as a “key fob, or simply “fob,” for example.) In one way of associating key 150 with driver 112, collection and initialization process 136 communicates with driver 112 in a manner such as described herein above to confirm that key 150 and its key identity data 154 corresponds to current driver 112 and driver identity data 120.

According to embodiments of the present invention, collection and initialization process 136 may store collected driver identity data 120 and driving data 122 on any or all of computer readable storage media 152 of key 150, computer readable storage media of GPS unit 104, or on computer readable storage media of vehicle control system 140. If collection and initialization process 136 stores driver identity data 120 or driving data 122 elsewhere, other than storage media 152 of key 150, then driver initialization process 136 also associates key identification data 154 for key 150 with driver identity data 120 and driving data 122 (and, likewise, associates driver identity data 120 with driving data 122) and stores key identification data 154 on the same media with driver identity data 120 and on the same media with driving data 122, so that data 120 and 122 may be retrieved for a particular driver 112 responsive to the key identification data 154 associated with the driver's key 150.

In embodiments of the present invention, key identification data 154 is stored on computer readable storage media 152 of key 150, but driver identity data 120 is stored elsewhere, such as on computer readable storage media of GPS unit 104, or on computer readable storage media of vehicle control system 140, for example. According to such embodiments of the present invention, a driver's key 150 has computer readable storage media 152 affixed to key 150 and accessible, either by electrical contact with key 150 via a communication path in a control system 140 of vehicle 106 or by wireless communication, for reading by an identification process 138, which is provided by execution of GPS application 130. Accordingly, identification process 138 reads key identification data 154 stored on media 152 by accessing key 150 computer readable storage media 152. Identification process 138 may then access whichever media has driver identity data 120 stored thereon and identifies driver identity data 120 associated thereon with key identification data 154 and may further cause vehicle control system 140 to generate a message on system 140, such as on a console display, stating the identity indicated by data 120, such as driver name, and requesting confirmation, such as by requesting the current driver 112 to select “Yes” or “No.”

Responsive to receiving a response from driver 112 indicating that he/she IS the person identified by data 120 on key 150, driver 112 Identification process 138 passes driver identification data 120 to a data analysis process 134.

Responsive to receiving a response from driver 112 indicating that he/she is NOT the person identified by data 120 on key 150, driver 112 Identification process 138 may perform above described actions for initializing driver identity data 120, which may, for example, cause a message requesting that the current driver 112 enter a different name, etc.

In embodiments of the present invention, wherein driver identity data 120 is stored on computer readable storage media 152 of key 150 in addition to, or in lieu of, key identification data 154, identification process 138 may read driver identity data 120 from media 152, i.e., without the need to look it up elsewhere based on key identification data 154 of media 152, otherwise, identification process 138 may further cause a message to request confirmation, cause a message requesting that the current driver 112 enter a different name when driver 112 does not confirm, etc., as described herein above.

In some embodiments of the present invention, wherein driving data 122 is stored on computer readable storage media 152 of key 150 in addition to, or in lieu of, key identification data 154. In those embodiments, once driver 112 has confirmed he/she is the driver associated with key 150 and driver identity data 120 stored thereon, identification process 138 may read driving data 122 from media 152, i.e., without the need to look it up elsewhere.

Driving data 122, like driver identity data 120, may be stored elsewhere other than on computer readable storage media 152 of key 150, according to embodiments of the present invention, such as on computer readable storage media of GPS unit 104, or on computer readable storage media of vehicle control system 140, for example.

In similar fashion as described above for driver identity data 120, identification process 138 accesses whichever media has driving data 122 stored thereon, identifies driving data 122 associated thereon with the current driver identification data 120 (i.e., current driver identification data 120, on key media 152 or elsewhere, that has been confirmed by the driver, as described above) and reads the identified driving data 122.

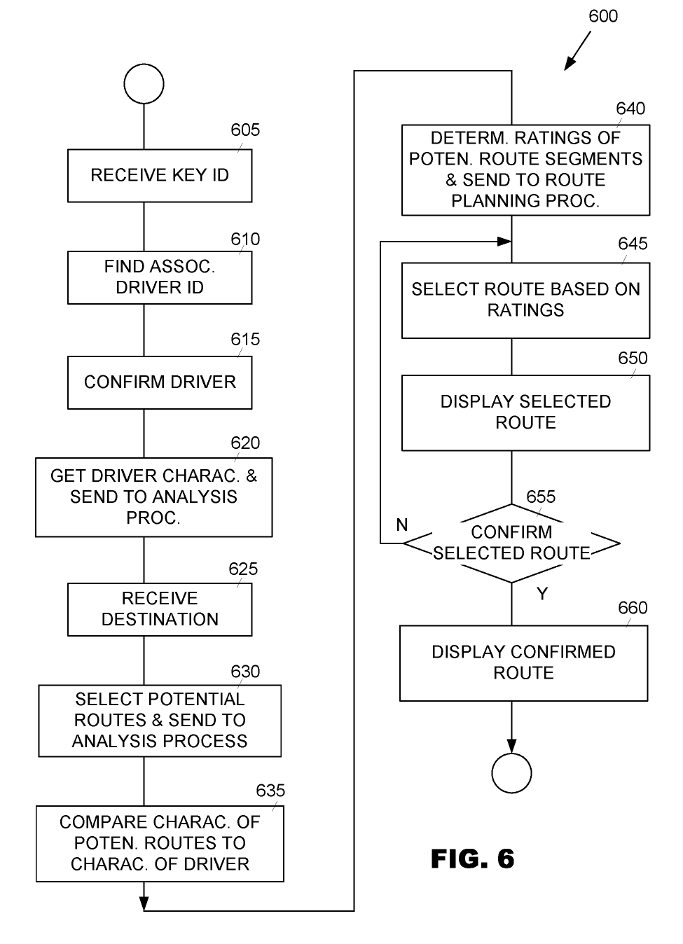

FIG. 6 illustrates actions, including actions performed by processes of a GPS, according to embodiments of the present invention. At 605 a GPS process receives key identifier data from the driver who is starting up the vehicle associated with the GPS. At 610 a GPS process finds driver identification associated with the key identification and then confirms the driver at 615 such as in a manner as has been described herein above. At 620 a process of the GPS gets driver characteristics data and sends it to an analysis process. At 625 the GPS receives input from the driver indicating a destination where the driver wants to go. At 630 a GPS planning process selects potential routes from the current location to the indicated destination and sends them to an analysis process of the GPS, which includes sending characteristics of the routes, which may include characteristics of segments of the routes. (The analysis process may also get additional characteristics of driver and the routes from other sources, such as networked data via an Internet connection.)

At 635 the analysis process compares the characteristics of the potential routes to the characteristics of driver and, at 640, determines ratings of the routes, such as avoidance ratings, which may include ratings of potential segments, responsive to the driver and route characteristics in a manner as has been described herein above, and sends the ratings to the planning process. In response, at 645, the planning process selects a route based on the ratings and displays 650 the selected route to the driver for the driver to confirm 655. If the driver does not confirm the route at 655, but indicates, rather, that the driver would prefer a different route, the planning process selects 645 an alternative route, which is once again based on the ratings, and displays 650 the alternative route, and so on until the driver confirms at 655, whereupon the GPS continues at 660 to display the confirmed route.

It should be appreciated that GPS device 104 may include elements shared by other systems, so that GPS device 104 is also referred to herein as a GPS. For example, display console 142 is shared by GPS 104 and vehicle control system 140, but may be considered part of the GPS. In another example, key 150 including memory 152 and key identify data 154 stored thereon, may be used by vehicle control system to enable operation of vehicle 106 in addition to use by GPS device 104, so that key 150, memory 152 and key identify data 154 may be considered part of the GPS. Host 116 may host applications other than application 114, which is for GPS device 104, but the GPS may include application 114 executing on host 116 and data 108 stored on host 116. Further, application 114 may include instances of processes 132, 134, 136, 138, etc. shown in FIG. 1 on GPS device 104.

One or more databases accessible by application 130 of GPS device 104 and/or application 114 of host 116 may be included in host 116 or GPS device 104 or elsewhere for storing and providing access to data for the various implementations. One skilled in the art will also appreciate that, for security reasons, any databases, systems, or components of the present invention may include any combination of databases or components at a single location or at multiple locations, wherein each database or system includes any of various suitable security features, such as firewalls, access codes, encryption, de-encryption and the like.

The database may be any type of database, such as relational, hierarchical, object-oriented, and/or the like. A database product that may be used to implement the databases is IBM® DB2®, or other available database products. (IBM and DB2 are trademarks of International Business Machines Corporation, registered in many jurisdictions worldwide.) The database may be organized in any suitable manner, including as data tables or lookup tables.

Association of certain data, such as driver identity data with driving data and key identification data, may be accomplished through any data association technique known and practiced in the art. For example, the association may be accomplished either manually or automatically. Automatic association techniques may include, for example, a database search, a database merge, GREP, AGREP, SQL, and/or the like. The association step may be accomplished by a database merge function, for example, using a key field in each of the manufacturer and retailer data tables. A key field partitions the database according to the high-level class of objects defined by the key field. For example, a certain class may be designated as a key field in both the first data table and the second data table, and the two data tables may then be merged on the basis of the class data in the key field. In this embodiment, the data corresponding to the key field in each of the merged data tables is preferably the same. However, data tables having similar, though not identical, data in the key fields may also be merged by using AGREP, for example.

Host 116 may provide a suitable website or other internet-based graphical user interface accessible by users. In one embodiment, Netscape web server, IBM® Websphere® Internet tools suite, an IBM DB2, universal database platform and a Sybase database platform are used in conjunction with a Sun Solaris operating system platform. (IBM and WebSphere are trademarks of International Business Machines Corporation, registered in many jurisdictions worldwide.) Additionally, components such as JBDC drivers, IBM connection pooling and IBM MQ series connection methods may be used to provide data access to several sources. The term webpage as it is used herein is not meant to limit the type of documents and applications that might be used to interact with the user. For example, a typical website might include, in addition to standard HTML documents, various forms, Java applets, Javascript, active server pages (ASP), Java Server Pages (JSP), common gateway interface scripts (CGI), extensible markup language (XML), dynamic HTML, cascading style sheets (CSS), helper applications, plug-ins, and the like.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While this specification contains many specifics, these should not be construed as limitations on the scope of the invention or of what can be claimed, but rather as descriptions of features specific to particular implementations of the invention. Certain features that are described in this specification in the context of separate implementations can also be implemented in combination in a single implementation. Conversely, various features that are described in the context of a single implementation can also be implemented in multiple implementations separately or in any suitable sub combination. Moreover, although features can be described above as acting in certain combinations and even initially claimed as such, one or more features from a claimed combination can in some cases be excised from the combination, and the claimed combination can be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the implementations described above should not be understood as requiring such separation in all implementations, and it should be understood that the described program components and systems can generally be integrated together in a single software product or packaged into multiple software products.

Those skilled in the art having read this disclosure will recognize that changes and modifications may be made to the embodiments without departing from the scope of the present invention.

It should be appreciated that the particular implementations shown and described herein are illustrative of the invention and its best mode and are not intended to otherwise limit the scope of the present invention in any way. Other variations are within the scope of the following claims.

The actions recited in the claims can be performed in a different order and still achieve desirable results. Likewise, the processes depicted in the accompanying figures do not necessarily require the particular order shown, or sequential order, to achieve desirable results. In certain implementations, multitasking and parallel processing can be advantageous.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims.

As used herein, the terms comprises, comprising, or any other variation thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as essential or critical.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed.

A GPS has been herein described that recommends a route based on driver characteristics, including demographic, etc. and history, e.g., accidents, tickets, etc., of vehicle operator and route characteristics. This may include rating of route segments based on the driver and route characteristics and may include weighting of the characteristics and of the ratings. The system may recommend a route based on determining from the characteristics that the route is the safest for current driver, i.e., vehicle operator, that the route fits a driving style of the vehicle operator, e.g., historical behavior, that the route avoids situations where the driver has limited experience, or based on a combination of one or more of the above. Many modifications and variations will be apparent to those of ordinary skill in the art without departing from the scope and spirit of the invention. The embodiments presented herein were chosen and described in order to best explain the principles of the invention and the practical application and to enable others of ordinary skill in the art to understand the invention for various embodiments with various modifications as are suited to the particular use contemplated. The description of the present invention has been presented for purposes of illustration and description, but is not intended to be exhaustive or limited to the invention in the form disclosed.

1. A method for global positioning system (“GPS”) routing, comprising:
receiving, by a GPS, demographic data for a current driver that includes data indicating age and gender and driving data for the current driver that includes data indicating past driving experience of the current driver, where the past driving experience includes respective amounts of past driving by the current driver on respective types of roads;
receiving, by the GPS, a destination location from a current driver of a vehicle;
identifying, by a GPS route planning process of the GPS, potential routes for the vehicle to the destination location;
rating, by a data analysis process of the GPS, the potential routes based on how characteristics of the potential routes relate to characteristics of the current driver, where the characteristics of the current driver include the current driver's age, gender and respective amounts of the current driver's past driving on respective types of roads, as indicated by the received demographic data and driving data;
selecting, by the GPS route planning process, a route for the current driver responsive to the ratings; and
displaying, by the GPS, the selected route to the driver on a display.

2-3. (canceled)

4. The method of claim 1, wherein the characteristics of the current driver comprise historical driving behavior.

5. The method of claim 4, wherein the driving behavior includes accidents and moving traffic violations.

6. The method of claim 1, wherein the characteristics of the potential routes comprise speed limits on respective segments of the potential routes.

7. The method of claim 1, wherein the ratings include ratings indicating to avoid a segment of a potential route.

8. A global positioning system (“GPS”) comprises:
a processor; and
computer readable storage media having instructions stored thereon for execution by the processor, wherein the instructions executed by the processor cause the processor to perform operations comprising:
receiving, by a GPS, demographic data for a current driver that includes data indicating age and gender and driving data for the current driver that includes data indicating past driving experience of the current driver, where the past driving experience includes respective amounts of past driving by the current driver on respective types of roads;
receiving, by the GPS, a destination location from a current driver of a vehicle;
identifying, by a GPS route planning process of the GPS, potential routes for the vehicle to the destination location;
rating, by a data analysis process of the GPS, the potential routes based on how characteristics of the potential routes relate to characteristics of the current driver, where the characteristics of the current driver include the current driver's age, gender and respective amounts of the current driver's past driving on respective types of roads, as indicated by the received demographic data and driving data;
selecting, by the GPS route planning process, a route for the current driver responsive to the ratings; and
displaying, by the GPS, the selected route to the driver on a display.

9-10. (canceled)

11. The system of claim 8, wherein the characteristics of the current driver comprise historical driving behavior.

12. The system of claim 11, wherein the driving behavior includes accidents and moving traffic violations.

13. The system of claim 8, wherein the characteristics of the potential routes comprise speed limits on respective segments of the potential routes.

14. The system of claim 8, wherein the ratings include ratings indicating to avoid a segment of a potential route.

15. A computer program product for global positioning system (“GPS”) routing, wherein the computer program product comprises a computer readable storage medium having instructions stored thereon for execution by a computer, and the instructions, when executed by the computer, cause the computer to perform operations comprising:
receiving, by a GPS, demographic data for a current driver that includes data indicating age and gender and driving data for the current driver that includes data indicating past driving experience of the current driver, where the past driving experience includes respective amounts of past driving by the current driver on respective types of roads;
receiving, by the GPS, a destination location from a current driver of a vehicle;
identifying, by a GPS route planning process of the GPS, potential routes for the vehicle to the destination location;
rating, by a data analysis process of the GPS, the potential routes based on how characteristics of the potential routes relate to characteristics of the current driver, where the characteristics of the current driver include the current driver's age, gender and respective amounts of the current driver's past driving on respective types of roads, as indicated by the received demographic data and driving data;
selecting, by the GPS route planning process, a route for the current driver responsive to the ratings; and
displaying, by the GPS, the selected route to the driver on a display.

16-17. (canceled)

18. The computer program product of claim 8, wherein the characteristics of the current driver comprise historical driving behavior.

19. The computer program product of claim 11, wherein the driving behavior includes accidents and moving traffic violations.

20. The computer program product of claim 8, wherein the characteristics of the potential routes comprise speed limits on respective segments of the potential routes.
